(19) United States
(12) Patent Application Publication
(10) Pub. No.: US 2008/0315034 A1
(43) Pub. Date: Dec. 25, 2008

(54) Turbojet Engine Nacelle with Lateral Opening of Covers

(76) Inventors: Guy Bernard Vauchel, Le Havre (FR); Laurent Marcel Vicogne, Le Havre (FR); Georges Alain Bouret, Epouville (FR); Xavier Cazuc, Rouelles (FR)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 12/159,111

(22) PCT Filed: Jan. 29, 2007
(86) PCT No.: PCT/FR2007/000161

§ 371 Date: Aug. 26, 2008

(30) Foreign Application Priority Data
Feb. 16, 2006 (FR) 06 01350

(51) Int. Cl. B64D 27/12; F02K 3/02

(52) U.S. Cl. 244/54; 60/226.2

(57) ABSTRACT

The present invention relates to a nacelle (1) of a turbojet engine (4), which nacelle is intended to be attached to a structure (2) of an aeroplane by a connecting pylori (3) and comprises at least one moving part (9′, 9′) above to be opened in order to provide access to the interior of the nacelle, characterized in that the said moving part is mounted to pivot about a pivot axis (25) directed along a line more or less perpendicular to the plane of the structure of the aeroplane to which the nacelle is attached.

The present invention relates to a nacelle of a turbojet designed to be attached to a structure of an aircraft by a connecting pylori and comprising at least one movable portion capable of being opened so as to allow access to the inside of the nacelle.

An aircraft is propelled by one or more propulsion assemblies comprising a turbojet housed in a tubular nacelle. Each propulsion assembly is attached to the aircraft via a pylori usually situated underneath a wing or at the fuselage. A nacelle usually has a structure comprising an air intake upstream of the engine, an upstream section designed to surround a fan of the turbojet, a mid-section accommodating thrust reversal means and designed to surround the combustion chamber of the turbojet, and an exhaust nozzle whose outlet is situated downstream of the turbojet.

In addition to accommodating the turbojet and to channeling the airflows that it generates, a nacelle also accommodates a set of accessory actuation devices associated with its operation and performing various functions when the turbojet is working or stopped.

There are usually three main accessory actuation systems incorporated into a nacelle, namely the radial opening of hoods for the maintenance of the turbojet, the deployment and retraction of movable covers, and the radial opening of the two semiportions of the thrust reverser for carrying out more advanced maintenance operations on the engine itself.

To do this, nacelle structures are known that are formed of two semiportions that are able to open radially about a longitudinal shaft situated in the vicinity of the pylori. Such a structure is called a “C-duct”.

A “C-duct” structure offers access to the engine for carrying out ground maintenance operations after unlocking systems for retaining the semiportions then pivoting the latter about the longitudinal shaft adjacent to the pylori by which the nacelle is connected to the wing or the fuselage. The semiportions are connected together at the bottom portion by locks.

Such a method of opening the nacelle however poses problems when the latter is close to the structure of the aircraft, particularly the wing. Specifically, during maintenance operations on the turbojet, the semiportions and hoods of the nacelle that are situated beneath the wing cannot be opened beyond a certain angle, the latter being blocked by the wing or more usually by the structure of the aircraft.

The result of this is a limited opening which reduces or even prevents access to certain zones of the nacelle and of the turbojet. It is possible in particular to cite the top zones of the turbojet, zones in which are situated many systems of control from the aircraft intended for the turbojet and the nacelle.

Furthermore, it may be necessary to replace elements covering the inside of the structure of the nacelle, such as heat guards for example, that are difficult to access because of the insufficient opening of the nacelle.

A solution is therefore to remove the nacelle. Such an operation is not usually desired because it is lengthy and costly. In addition, it requires considerable labor.

It will also be possible to note that the radial opening of the semiportions or of the hoods requires the presence of powerful opening cylinders inside the nacelle, these cylinders having to be capable of supporting the weight of the hoods or semiportions, and connecting rods making it possible to secure these hoods and semiportions in the open position. These elements represent considerable weight and occupy considerable space.

The object of the present invention is to remedy the disadvantages mentioned above and for that reason consists in a nacelle of a turbojet designed to be attached to a structure of an aircraft by a connecting pylori and comprising at least one movable portion capable of being opened so as to allow access to the inside of the nacelle, characterized in that said movable portion is mounted so as to pivot about a pivot shaft oriented along a shaft that is substantially perpendicular to the plane of the structure of the aircraft to which the nacelle is attached.

Therefore, by providing an opening by pivoting about a shaft that is no longer parallel to the plane of the structure of the aircraft to which the nacelle is attached (longitudinal in the case of an underwing attachment), but perpendicular (that is to say substantially perpendicular in the case of an underwing attachment), the movable portion is not hampered by the structure of the aircraft to which it is attached and may therefore be opened more widely so as to allow total access to the inside of the nacelle and to the engine. In addition, since it is no longer necessary to raise the movable portion, the opening may if necessary be carried out manually or with the aid of less powerful actuation means.

Advantageously, the pivot shaft is mounted on the nacelle thanks to movement means capable of allowing a lateral movement of said pivot shaft. This makes it possible to slightly separate the movable portion of the nacelle in order to allow a yet greater opening.

Again advantageously, the pivot shaft is mounted on the nacelle thanks to movement means capable of allowing said pivot shaft to tilt relative to its initial direction. Therefore it is possible to further optimize the opening of the movable portion.

Preferably, the movable portion comprises a knife capable of housing in a groove arranged in a fixed portion of the nacelle and capable of preventing the rotation of the movable portion in the absence of a prior separation of the pivot shaft for the purpose of disengaging the knife from the groove. Such means make it possible to lock the movable portion in the closed position. Evidently it is possible to provide other commonly used locking means.

Preferably, the movement means are cylinders having a first end anchored in a fixed portion of the nacelle and a second end attached to the pivot shaft of the movable portion. Advantageously, the cylinders are electric cylinders. Alternately, it is possible to envisage a rail/runner system that is able to be maneuvered manually or be motorized.

Preferably, at least one movable portion is a semiportion of a thrust reverser. Advantageously, the pivot shaft is situated substantially at a front frame of the thrust reverser.

Again preferably, at least one movable portion is a fan cover.

Advantageously, the nacelle comprises actuation means capable of causing the movable portion to pivot about the pivot shaft. Again advantageously, the actuation means are cylinders that are preferably electric.

Advantageously, the nacelle comprises at least one safety connecting rod having a first end attached to a fixed structure of the nacelle and a second end attached to the movable portion, preferably on its upstream structure, said safety connecting rod being capable of passing alternately from a position in which it prevents the closure of the movable portion to a position in which it allows its closure.

The embodiment of the invention will be better understood with the aid of the detailed description that is set out below with respect to the appended drawing in which:

FIG. 1 is a front view in cross section of a nacelle according to the invention in the closed position.

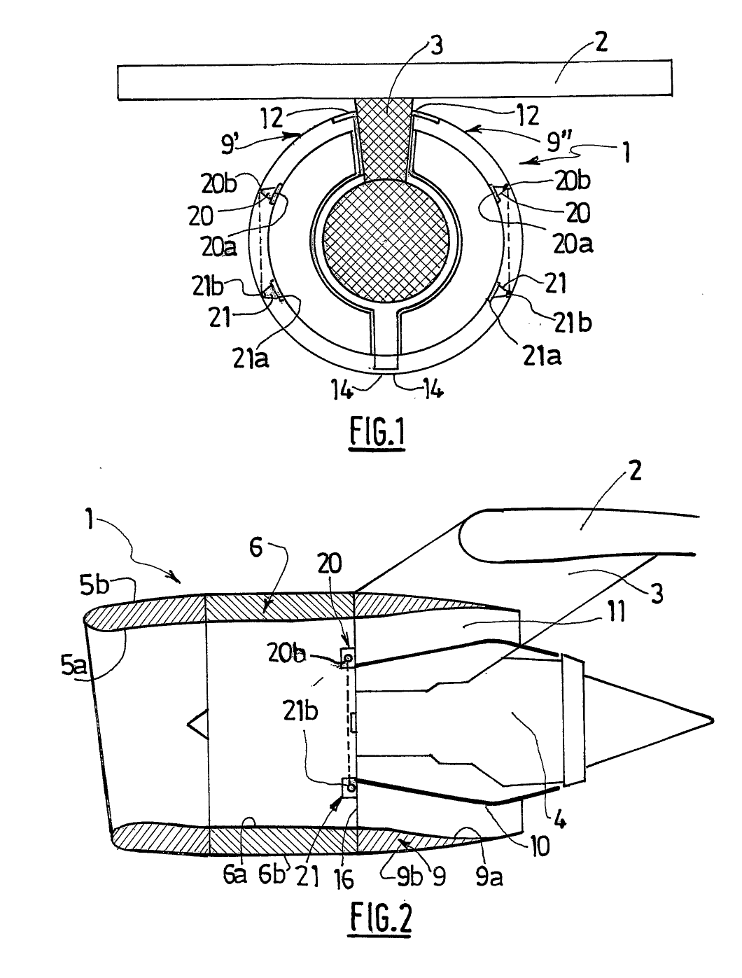

FIG. 2 is a side view in longitudinal section of the nacelle of FIG. 1.

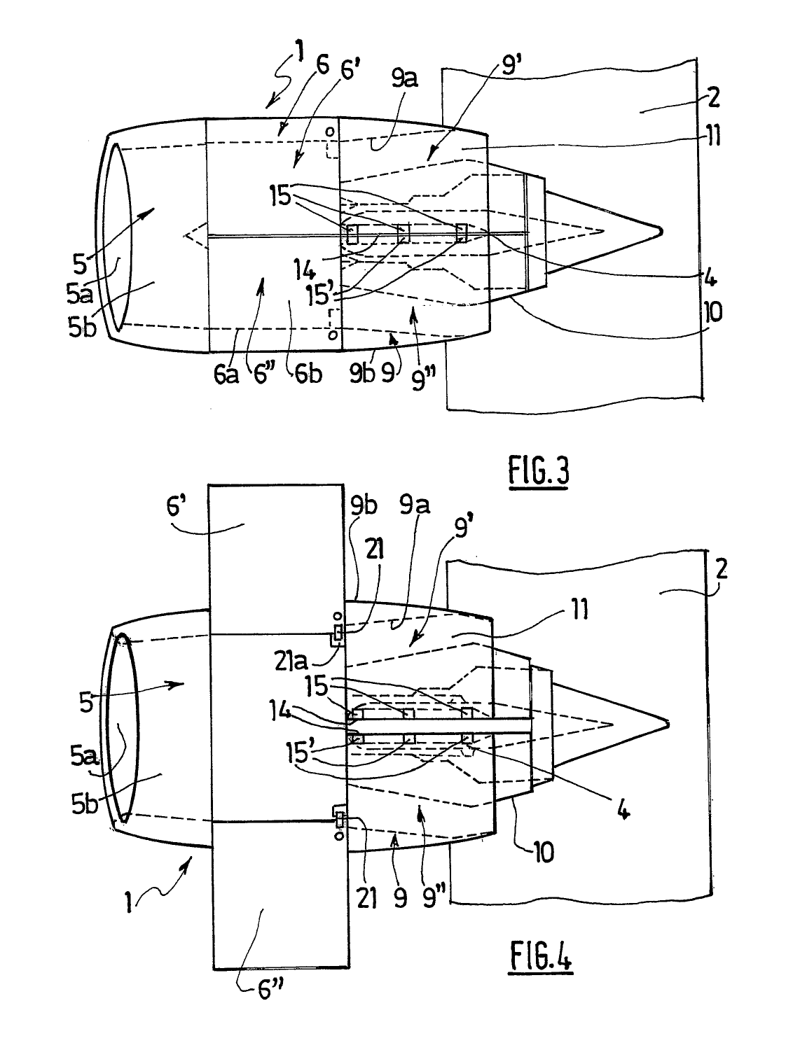

FIG. 3 is a bottom view of the nacelle of FIG. 1.

FIG. 4 is a bottom view of the nacelle of FIG. 1 being opened.

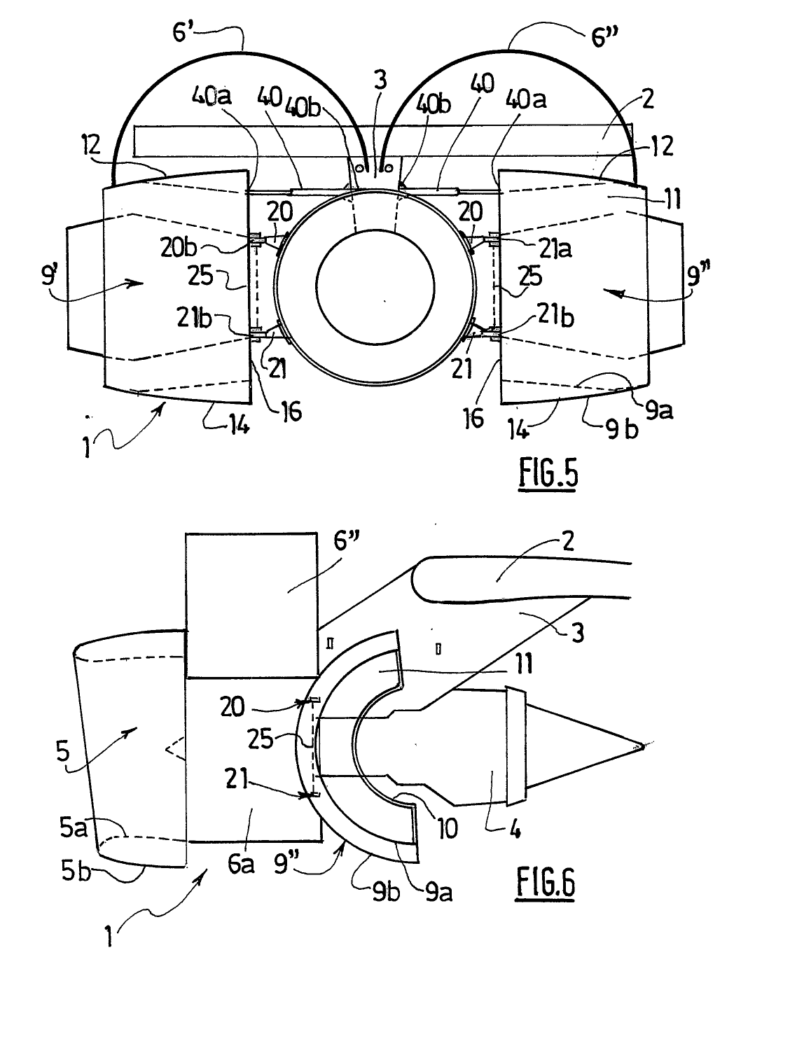

FIG. 5 is a front view of the nacelle of FIG. 1 in the open position.

FIG. 6 is a side view of the nacelle of FIG. 5.

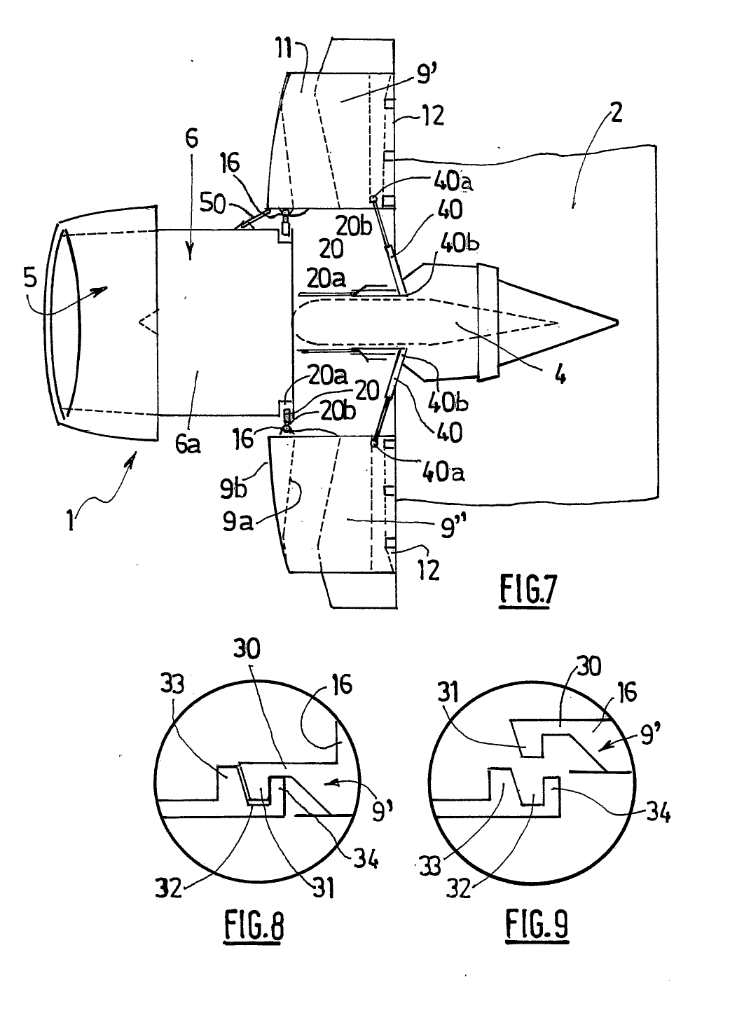

FIG. 7 is a bottom view of the nacelle of FIG. 5.

FIGS. 8 and 9 show an enlargement of the locking between the movable portion and the structure of the nacelle.

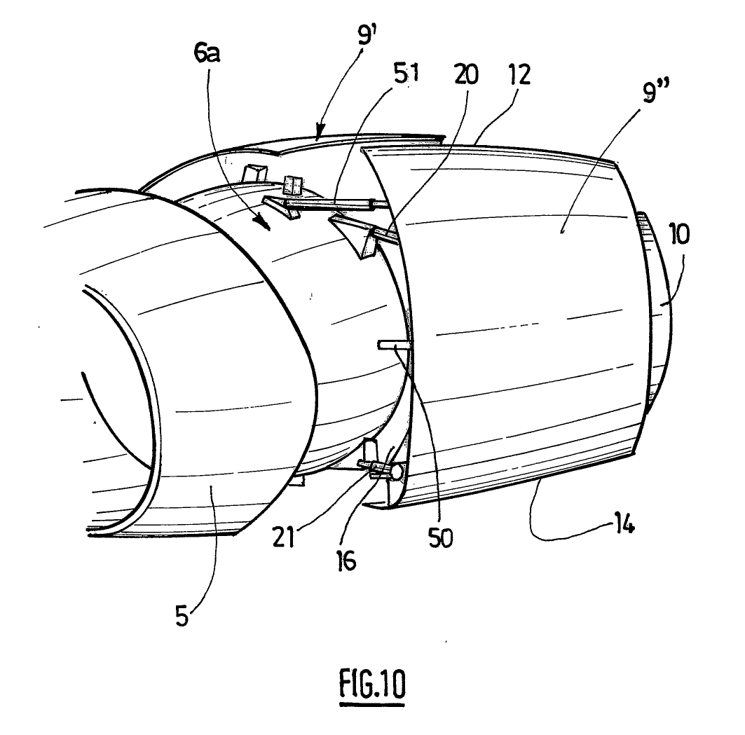

FIG. 10 is a schematic representation of a nacelle according to the invention whose opening is mechanically assisted.

A nacelle 1 according to the invention as shown in FIGS. 1 to 7 is designed to be attached beneath a wing 2 of an aircraft (not visible) by means of an oblique pylori 3 oriented toward the front of the aircraft.

This nacelle 1 forms a tubular housing for a turbojet 4 for which it is used to channel the airflows that it generates. It also accommodates various components necessary to the operation of the turbojet 4.

More precisely, the nacelle 1 has an external structure comprising a front section forming an air intake 5, a mid-section 6 surrounding a fan of the turbojet, and a rear section 9 surrounding the engine and accommodating a thrust reverser system (not visible).

The air intake 5 has an internal surface 5a designed to channel the incoming air and an external streamlining surface 5b.

The mid-section 6 comprises, on the one hand, an internal casing 6a surrounding the fan of the turbojet 4, and on the other hand, an external structure 6b for streamlining the casing extending the external surface 5b of the air intake section 5. The casing 6a is attached to the air intake section 5 which it supports and extends its internal surface 5a. The external streamlining structure 6b is made in the form of movable covers 6′, 6″ situated on either side of the nacelle 1 relative to the shaft of the pylori 3 and joined together under the nacelle. Each cover 6′, 6″ is mounted so as to pivot about a substantially horizontal shaft situated close to the pylori 3.

The rear section 9 extends the mid-section 6 and comprises an external structure having an internal surface 9a in the continuity of the casing 6a and an external surface 9b in the continuity of the external streamlining structure 6b of the mid-section 6. It also comprises an internal streamlining structure 10 of the engine defining with the internal surface 9a a path 11 designed for the movement of a cold air flow in the case of a turbofan engine as shown here.

The rear section 9 is made in the form of two lateral semiportions 9′, 9″ situated on either side of the nacelle 1.

Each semiportion 9′, 9″ comprises a top edge 12 fitted with bolts (not visible) capable of interacting with the pylori 3 and a bottom edge 14 fitted with locking means 15′, 15″ capable of interacting with matching locking means 15″, 15′ of the bottom edge 14 of the other semiportion 9″, 9′. The whole of the external structure of the rear section 9 and of the internal structure 10 of each semiportion 9′, 9″ is supported by a front frame 16 itself supported by the casing 6a with which it is pivotingly mounted.

To do this, each front frame 16 is connected to the casing 6a surrounding the fan by means of a top cylinder 20 and a bottom cylinder 21 parallel with one another and substantially horizontal, each having a first fixed end 20a, 21a anchored to the casing 6a and a second end 20b, 21b attached to the front frame 16 via a swivel joint (not shown). The second end 20b of the top cylinder 20 and the second end 21b of the bottom cylinder 21 define a substantially vertical shaft 25 around which the corresponding semiportion 9′, 9″ is capable of pivoting.

As a variant, each semiportion 9′, 9″ may be attached to the casing 6a by means of simple articulation points likewise defining a transverse shaft 25 on which the corresponding semiportion 9′, 9″ is mounted so as to pivot about said shaft 25.

As a variant also the top cylinders 20 and the bottom cylinders 21 may be attached to the corresponding semiportion 9′, 9″ by a simple connection allowing the semiportion 9′, 9″ to rotate about the shaft 25 defined by the second ends 20b, 21b of the cylinders 20, 21.

The advantages provided, on the one hand, by the cylinders 20, 21 and on the other hand by a swivel joint connection will be discussed in detail in the part describing the opening of the nacelle 1.

In addition, each semiportion 9′, 9″ is fitted with a locking system capable of interacting with matching locking means of the casing 6a. Such a system is shown in detail in FIGS. 8 and 9. The front frame 16 of each semiportion 9′, 9″ has a longitudinal extension 30 terminated by a return forming a knife 31 oriented in the direction of the casing 6a.

This knife 31 is designed to interact with a groove 32 fitted to the casing 6a and having an external edge 33 and an internal edge 34. The operation of the locking system will be explained when the opening of the nacelle 1 is described.

The nacelle 1 is completed by a system for securing the opening and closure of the semiportions 9′, 9″ of the rear section 9.

This system comprises, for each semiportion 9′, 9″, a telescopic arm 40 forming a connecting rod and having a first end 40b attached to the engine 4 downstream of the rear section 9 and a second end 40a attached to the corresponding semiportion 9′, 9″, advantageously on the internal structure 10. This system also comprises means for locking the telescopic arm 40 in its extended position.

A user wishing to open the nacelle 1 will proceed as follows.

First of all, each semiportion 9′, 9″ must be cleared by opening the movable covers 6′, 6″ forming the external structure 6b of the mid-section 6. The mid-section 6 being situated slightly in front of the wing 2, the covers 6′, 6″ can be fully opened without being hampered by said wing 2. If necessary, the principle of lateral opening according to the invention may be applied to the covers 6′, 6″, their pivoting axes then being situated preferably upstream of said covers 6′, 6″.

It is then necessary to unlock the top bolts 13 and the bottom locking means 15, 15′ fitted to each semiportion 9′, 9″. The unlocking may be manual, electric, remotely controlled or another method.

The unlocking is then carried out at the connection between the casing 6a and the front frame 16. Specifically, the external edge 33 of the groove 32 presented by the casing 6a prevents the semiportion 9′, 9″ from pivoting by retaining the knife 31. The knife 31 is extracted from said groove 32 by deploying the bottom cylinders 20 and the top cylinders 21 on which each semiportion 9′, 9″ is mounted. Accordingly each semiportion 9′, 9″ moves away laterally, then disengaging the knife 31 from the groove 32, and may pivot about the corresponding pivot shaft.

The deployment of the cylinders 20, 21 may be simultaneous so as to carry out a rectilinear translation of the pivot shaft 25 or be different for the top cylinder 20 and bottom cylinder 21, then carrying out a tilting of the pivot shaft 25 depending on what is desired.

Thus unlocked, an operator can manually open the semiportions 9′, 9″. Alternately, the rotation may be mechanically assisted or totally carried out by an electric or pneumatic cylinder (not shown).

It should be noted that the figures represent the semiportions 97, 9″ in an open configuration approximate to 90°. Clearly the angle of opening may be more or less than that shown, said angle of opening being defined according to the access to the turbojet 4 that is required.

During the opening, the telescopic arm 40 forming the safety connecting rod passes first of all through a retraction phase before passing through an extension phase in order to terminate by being locked in the desired lengthened position corresponding to the opening of the semiportion 97, 97.

Alternately or additionally, the semiportion 9′ may be locked in the open position by means of its external structure 9b by attaching it via a hook 50 or straps to an eyelet (not visible) fitted to the casing 6a.

According to the possible tilting of the pivot shaft 25 notably when the latter is oriented toward the bottom of the nacelle and forms an acute angle with a vertical shaft of the nacelle, the very weight of the semiportions 97, 997 may be sufficient to keep the semiportions 9′, 9″ in the open position without further need of mechanical securing.

The nacelle 1 is closed by carrying out the reverse steps. During the locking of the front frame 16 of each semiportion 99, 977 onto the casing 6a, the knife 31 is guided into the groove 32 by the external edge 33 which may if necessary be extended radially according to the desired clearance and guidance.

In closure, it is possible to provide an abutment marking the end of the closure travel of the semiportions 9′, 9″, situated substantially at 12 o'clock and/or 6 o'clock for each semiportion 9′, 9″. Each abutment has a slot capable of interacting with a system of rollers of the corresponding semiportion 9′, 9″. This makes it possible to guide the semiportion 9′, 9″ when it is separated laterally and during its closure and to support a portion of the forces being exerted on the cylinders 20, 21.

As shown in FIG. 10 and as explained above, each semiportion 9′, 9″ may be actuated mechanically by a cylinder 51, preferably an electric cylinder attached, on the one hand, to the casing 6a and, on the other hand, to the upstream structure of the corresponding semiportion 9′, 9″.

Although the invention has been described in connection with particular exemplary embodiments, it is evident that it is in no way limited thereto and that it comprises all the technical equivalents of the means described and their combinations if the latter are included in the context of the invention. More precisely, it should be noted that the principle of a lateral opening according to the invention is not limited to the semiportions 9′, 9″ of the reverser but may also be applied to the covers 6′, 6″ surrounding the casing 6 of the fan. In this case, the pivot shaft will preferably be situated upstream of the covers 6′, 6″. In addition, the principle of a lateral opening of the covers is not limited to a nacelle attached underneath a wing 2 of an aircraft but may be easily adapted for other locations such as a fuselage for example.

1. A nacelle of a turbojet designed to be attached to a structure of an aircraft by a connecting pylon and comprising at least one movable portion capable of being opened so as to allow access to the inside of the nacelle, characterized in that said movable portion is mounted so as to pivot about a pivot shaft oriented along a shaft that is substantially perpendicular to the plane of the structure of the aircraft to which the nacelle is attached.

2. The nacelle as claimed in claim 1, characterized in that the pivot shaft is mounted on the nacelle thanks to movement means capable of allowing a lateral movement of said pivot shaft.

3. The nacelle as claimed in claim 1, characterized in that the pivot shaft is mounted on the nacelle thanks to movement means capable of allowing said pivot shaft to tilt relative to its initial direction.

4. The nacelle as claimed in claim 2, characterized in that the movable portion comprises a knife capable of housing in a groove arranged in a fixed portion of the nacelle and capable of preventing the rotation of the movable portion in the absence of a prior separation of the pivot shaft for the purpose of disengaging the knife from the groove.

5. The nacelle as claimed in claim 2, characterized in that the movement means are cylinders having a first end anchored in a fixed portion of the nacelle and a second end attached to the pivot shaft of the movable portion.

6. The nacelle as claimed in claim 5, characterized in that the cylinders are electric cylinders.

7. The nacelle as claimed in claim 1, characterized in that at least one movable portion is a semiportion of a thrust reverser.

8. The nacelle as claimed in claim 7, characterized in that the pivot shaft is situated substantially at a front frame of the thrust reverser.

9. The nacelle as claimed in claim 1, characterized in that at least one movable portion is a fan cover.

10. The nacelle as claimed in claim 1, characterized in that it comprises actuation means capable of causing the movable portion to pivot about the pivot shaft.

11. The nacelle as claimed in claim 10, characterized in that the actuation means are cylinders that are preferably electric.

12. The nacelle as claimed in claim 1, characterized in that it comprises at least one safety connecting rod having a first end attached to a fixed structure of the nacelle and a second end attached to the movable portion, preferably on its upstream structure, said safety connecting rod being capable of passing alternately from a position in which it prevents the closure of the movable portion to a position in which it allows its closure, preferably via a remote control.
